(19) United States
(12) Patent Application Publication
(10) Pub. No.: US 2022/0412457 A1
(43) Pub. Date: Dec. 29, 2022

(54) DRIVE DEVICE

(71) Applicant: DENSO CORPORATION, Kariya-city (JP)

(72) Inventor: Daisuke NAKANISHI, Kariya-city (JP)

(21) Appl. No.: 17/850,184

(22) Filed: Jun. 27, 2022

(30) Foreign Application Priority Data
Jun. 29, 2021 (JP) 2021-107748

(51) Int. Cl. F16H 61/32; F16D 23/10; F16H 63/30

(52) U.S. Cl. CPC F16H 61/32; F16D 23/10; F16H 63/304; F16H 2061/283

(57) ABSTRACT

A drive device includes: an actuator rotating, around a rotation axis, a shift drum having a lead groove formed on an outer peripheral surface; and an angle correction unit correcting a detection value of a rotation angle sensor that detects a rotation angle of the shift drum. The angle correction unit calculates the rotation angle of the shift drum at a reference position as a learning angle based on a correspondence between a displacement amount of a first engaging portion and a change amount of the rotation angle of the shift drum per a predetermined time of rotation of the shift drum at a predetermined speed. Then, the angle correction unit corrects the detection value of the rotation angle sensor based on an amount of deviation between the learning angle and a design angle.

### CROSS REFERENCE TO RELATED APPLICATION

The present application is based on and claims the benefit of priority of Japanese Patent Application No. 2021-107748, filed on Jun. 29, 2021, the disclosure of which is incorporated herein by reference.

### TECHNICAL FIELD

The present disclosure generally relates to a clutch drive device.

### BACKGROUND ART

Comparatively, regarding a device that rotates a shift drum to shift gears, a technique is known for correcting an output of an angle sensor based on a detection angle of the angle sensor), in which an end wall is provided in a lead groove on an outer circumference of the shift drum, and the detection angle of the angle sensor is picked up when a pin of a shifter touches the end wall in the lead groove.

### SUMMARY

It is an object of the present disclosure to provide a clutch drive device capable of improving the detection accuracy of the rotation angle of a shift drum while expanding the scope of application.

### BRIEF DESCRIPTION OF THE DRAWINGS

Objects, features, and advantages of the present disclosure will become more apparent from the following detailed description made with reference to the accompanying drawings, in which:

FIG. 1 is a schematic configuration diagram of a clutch system according to a first embodiment;

FIG. 2 is an explanatory diagram for explaining a timing at which an elastic member is compressed;

FIG. 3 is an explanatory diagram for explaining a state in which a length of the elastic member becomes a free length;

FIG. 4 is a developed view of a lead groove developed in a rotation direction of a shift drum;

FIG. 5 is an explanatory diagram for explaining an output of a rotation angle sensor;

FIG. 6 is an explanatory diagram for explaining an output of a stroke sensor;

FIG. 7 is an explanatory diagram for explaining a reference position of a first dog member;

FIG. 8 is an explanatory diagram for explaining a relationship between a rotation angle of the shift drum and a displacement amount of the first dog member;

FIG. 9 is a flowchart showing a flow of clutch operation process performed by a control unit according to the first embodiment;

FIG. 10 is an explanatory diagram for explaining switching of a clutch to a disengage state;

FIG. 11 is a block diagram for explaining F/B control by the control unit;

FIG. 12 is a flowchart showing a flow of learn process performed by an angle correction unit according to the first embodiment;

FIG. 13 is an explanatory diagram for explaining a method of estimating a rotation angle of the shift drum at a connection point;

FIG. 14 is a timing chart for explaining a learn process performed by the angle correction unit according to the first embodiment;

FIG. 15 is a flowchart showing a flow of learn process performed by the angle correction unit according to a second embodiment;

FIG. 16 is a timing chart for explaining an accuracy improvement process performed by the angle correction unit according to the second embodiment;

FIG. 17 is a timing chart for explaining a learn process performed by the angle correction unit according to the second embodiment;

FIG. 18 is a schematic configuration diagram of a transmission according to the first embodiment;

FIG. 19 is an explanatory diagram for explaining a relationship between the rotation angle of the shift drum and the displacement amount of each clutch;

FIG. 20 is an explanatory diagram for explaining a relationship between the rotation angle of the shift drum and a state of each clutch;

FIG. 21 is an explanatory diagram for explaining an example of an operation of the shift drum when switching from a first state to a fourth state and engaging and disengaging a first clutch; and

FIG. 22 is an explanatory diagram for explaining another example of the operation of the shift drum when switching from the first state to the fourth state and engaging and disengaging the first clutch.

### DETAILED DESCRIPTION

Hereinafter, embodiments of the present disclosure will be described with reference to the drawings.

In the following embodiments, components and/or configurations, which are the same as or equivalent to those described in the preceding embodiment(s), will be indicated by the same reference signs, and the description thereof may be omitted.

Also, in the following embodiments, when only some of the constituent elements are described, corresponding constituent elements of a previously described one or more of the embodiments may be applied to the rest of the constituent elements.

The following embodiments may be partially combined with each other even if such a combination is not explicitly described as long as there is no disadvantage with respect to such a combination.

### First Embodiment

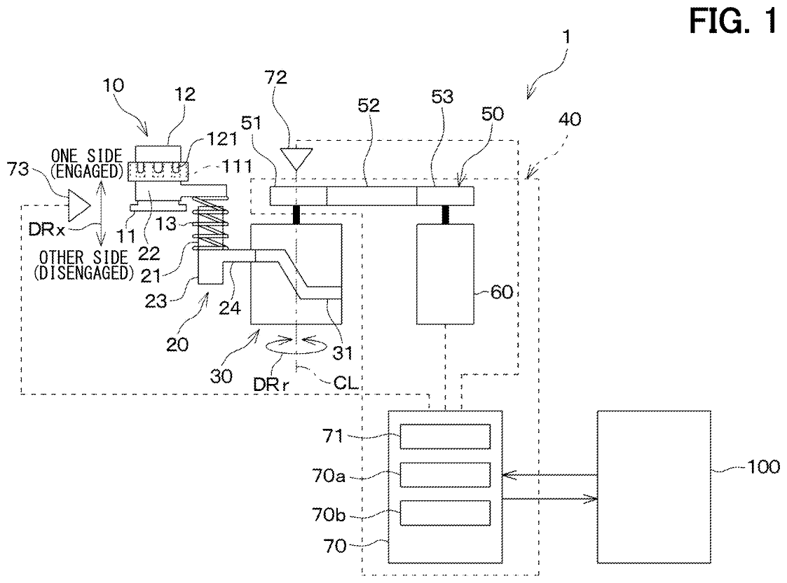

The present embodiment will be hereinafter described with reference to FIGS. 1 to 14. In the present embodiment, an example in which a drive device 40 of the present disclosure is applied to a clutch system 1 of a hybrid vehicle will be described. In FIG. 1 and the like, a direction extending along a rotation axis CL of a shift drum 30, which will be described later, is schematically shown as an axial direction DRx, also known as a vertical direction, pointing upwards as shown in FIG. 1.

The clutch system 1 is a system that interrupts the transmission of power output from a drive source such as an internal combustion engine or a traveling motor to an axle. As shown in FIG. 1, the clutch system 1 includes a clutch 10, a shift fork 20, the shift drum 30, and the drive device 40.

The clutch 10 is configured as a so-called dog clutch. The clutch 10 has a first dog member 11 (also known as a mobile engaging portion 11) and a second dog member 12 (also known as a static engaging portion 12). The first dog member 11 and the second dog member 12 are arranged to face each other in the axial (or vertical) direction DRx.

The first dog member 11 is formed in a substantially cylindrical shape. The first dog member 11 is a rotating member that can rotate about its axis (a vertical axis that is preferably not coaxial with the rotation axis CL of the shift drum 31). The first dog member 11 is connected to the shift drum 30 via the shift fork 20 so that the first dog member 11 can be displaced in the axial direction DRx (vertically upwards to engage, and vertically downwards to disengage). The first dog member 11 is formed with a plurality of first engaging teeth 111 at a portion facing the second dog member 12. The plurality of first engaging teeth 111 project upwards in the axial DRx direction. The plurality of first engaging teeth 111 are arranged at predetermined intervals from each other along a circumferential direction of the first dog member 11.

The second dog member 12 is formed in a substantially cylindrical shape. The second dog member 12 is a rotating member that can rotate about its axis. The second dog member 12 is configured to be non-displaceable (static) in the axial direction DRx. The second dog member 12 is formed with a plurality of second engaging teeth 121 that engage with the first engaging tooth 111 at a portion facing the first dog member 11. The plurality of second engaging teeth 121 project downwards in the axial direction DRx. The plurality of second engaging teeth 121 are arranged at predetermined intervals from each other along the circumferential direction of the second dog member 12.

The clutch 10 is switchable, according to the displacement of the first dog member 11 in the axial direction DRx, between (i) an engaged state in which the first dog member 11 and the second dog member 12 rotate integrally and (ii) a disengaged state in which the first dog member 11 and the second dog member 12 do not rotate integrally. In the clutch 10 of the present embodiment, the first dog member 11 and the second dog member 12 form a “pair of engaging portions.” Specifically, the first dog member 11 constitutes “one engaging portion” of the “pair of engaging portions,” and the second dog member 12 constitutes “the other engaging portion” of the “pair of engaging portions.” The first dog member 11 is also known as the mobile engaging portion 11, and the second dog member 12 is also known as the static engaging portion 12.

The clutch 10 of the present embodiment has an elastic member 13 that is compressed when transitioning from the disengaged state to the engaged state. The elastic member 13 is provided to absorb an impact when the first dog member 11 is engaged with the second dog member 12. The elastic member 13 is a member that expands and contracts in the axial direction DRx. The elastic member 13 is composed of, for example, a coil spring.

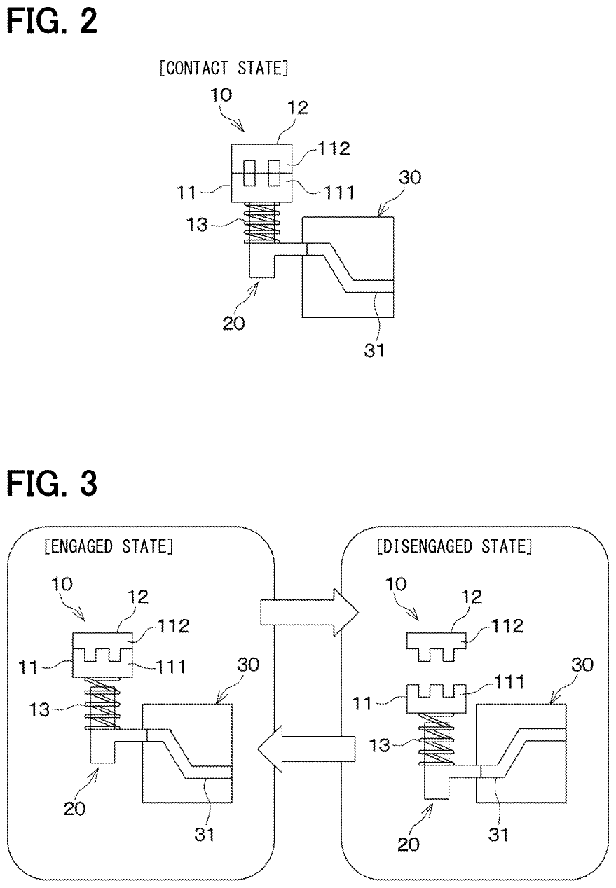

As shown in FIG. 2, the elastic member 13 is compressed, i.e., has a shorter length, in a contact state where an end face of the first engaging tooth 111 of the first dog member 11 and an end face of the second engaging tooth 111 of the second dog member 12 are in contact with each other. In the embodiment as shown in FIG. 3, in another state such as an engaged state in which the first dog member 11 and the second dog member 12 are engaged or a disengaged state, the length of the elastic member 13 becomes a free length. The free length may be limited to a maximum value (not shown). The above-described contact state (with a compressed elastic member 13) occurs only when transitioning from the disengaged state to the engaged state, and does not occur when transitioning from the engaged state to the disengaged state. Therefore, a biasing force of the elastic member 13 acts only when transitioning from the disengaged state to the engaged state, and has no particular effect when transitioning from the engaged state to the disengaged state.

The shift fork 20 is a connecting member that connects the first dog member 11 and the shift drum 30. The shift fork 20 includes, a shaft 21 extending in the axial direction DRx, a sleeve 22 connected to the first dog member 11 on one side in the axial direction DRx of the shaft 21, and a head 23 connected to the shift drum 30 on the other side in the axial direction DRx of the shaft 21.

The sleeve 22 is coupled with the first dog member 11 such that the sleeve 22 does not rotate integrally with the first dog member 11. Further, the sleeve 22 is connected to the shaft 21 via the elastic member 13. IN FIG. 1, the first dog member 11 may rotate within the sleeve 22.

The head 23 is connected to the shaft 21. The head 23 is provided with an engagement pin 24 that engages with a lead groove 31 formed on the outer peripheral surface of the shift drum 30. The engagement pin 24 is a coupling member that couples the head 23 with the shift drum 30. The engagement pin 24 protrudes horizontally toward the shift drum 30, and penetrates the lead groove 31.

When the shift drum 30 rotates, the shift fork 20 configured in such manner is displaced in the axial direction DRx according to the shape of the lead groove 31. At such moment, the clutch 10 is engaged and/or disengaged by the displacement of the first dog member 11 together with the sleeve 22 of the shift fork 20 in the axial direction DRx.

The shift drum 30 is a member that transmits the power of an actuator 60, which will be described later, to the shift fork 20. The shift drum 30 is rotated about a predetermined rotation axis CL by the actuator 60 that is described later. The shift drum 30 has a substantially cylindrical shape. The shift drum 30 has the lead groove 31 formed on an outer peripheral surface of the shift drum 30 with which the engagement pin 24 is engaged.

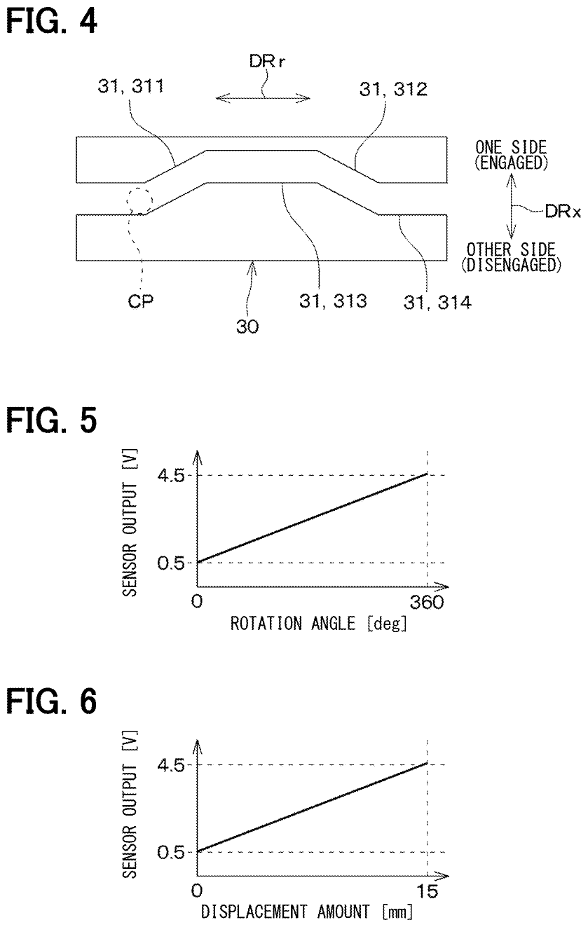

In one embodiment, the lead groove 31 is a groove portion formed continuously in a circumferential direction DRr of the rotation axis CL. As shown in FIG. 4, the lead groove 31 is formed continuously over the entire circumference along the circumferential direction DRr of the shift drum 30 so that the shift drum 30 can rotate 360 degrees. That is, the lead groove 31 of the shift drum 30 does not have an end wall for stopping the engagement pin 24. The lead groove 31 includes a first slope groove portion 311, a second slope groove portion 312, a first flat groove portion 313, and a second flat groove portion 314.

In another embodiment, the groove portion may not extend continuously around the entire drum. Also, in one embodiment, only one slope groove portion is used. For example, if the shift drum 30 in FIG. 1 shows the entire lead groove, then the slope groove portion will move the engagement pin 20 upwards during shift drum rotation in a first direction, and will move the engagement pin downwards during shift drum rotation in an opposite direction.

In FIG. 4, the first slope groove portion 311 and the second slope groove portion 312 are slope groove portions that are inclined with respect to the axial direction DRx to displace the first dog member 11 in the axial direction DRx. The first slope groove portion 311 and the second slope groove portion 312 extend linearly along a direction intersecting the circumferential direction DRr.

The first flat groove portion 313 (known as an engaged flat groove portion 313) and the second flat groove portion 314 (also knowns as a disengaged flat groove portion 314) are flat groove portions connected to the slope groove portions 311 and 312 to stop the displacement of the first dog member 11 in the axial direction DRx. The first flat groove portion 313 and the second flat groove portion 314 extend horizontally along the circumferential direction DRr. That is, both ends of the first flat groove portion 313 in of the circumferential direction DRr and the second flat groove portion 314 are substantially the same “height” in the axial direction DRx.

Specifically, the first slope groove portion 311 has one end in the circumferential direction DRr connected to the other end of the first flat groove portion 313, and has the other end in the circumferential direction DRr connected to one end of the second flat groove portion 314. Also, the second slope groove portion 312 has one end in the circumferential direction DRr connected to the other end of the second flat groove portion 314, and has the other end in the circumferential direction DRr connected to one end of the first flat groove portion 313. To summarize, there are four distinct groove portions in series: 311, 313, 312, and 314, reading FIG. 4 from left to right. Further, these groove portions may circumnavigate the shift drum, to form a continuous circumferential groove.

The first flat groove portion 313 is formed at a portion of the shift drum 30 on one side in the axial direction DRx. When the shift drum 30 rotates and the engagement pin 24 moves from either one of the slope groove portions 311, 312 to the first flat groove portion 313, the shift fork 20 is displaced to one side in the axial direction DRx, (vetically upwardly in FIG. 1) and the first dog member 11 moves, i.e., is displaced to an engaging position where it engages with the second dog member 12. Thus, the first flat groove portion 313 is also known as the engaged flat groove portion 313. The second flat groove portion 314 is also known as the disengaged flat groove portion 314.

Further, the second flat groove portion 314 is formed at a position of the shift drum 30 on the other side in the axial direction DRx. When the shift drum 30 rotates and the engagement pin 24 moves from either one of the slope groove portions 311, 312 to the second flat groove portion 314, the shift fork 20 is displaced to the other side in the axial direction DRx, and the first dog member 11 moves, i.e., is displaced to a disengage position where the engagement with the second dog member 12 is disengaged.

The drive device 40 is a member that drives the shift drum 30. The drive device 40 includes, a speed reducer 50, the actuator 60 that outputs power for rotating the shift drum 30 via the speed reducer 50, and a control device 70 that controls the actuator 60.

The speed reducer 50 decelerates the rotation output from the actuator 60, and outputs the rotation to the shift drum 30. The speed reducer 50 has three speed reduction gears 51, 52, and 53. The speed reducer 50 may be configured to include one or two gears or four or more gears.

The actuator 60 rotates the shift drum 30 around a predetermined rotation axis CL. The actuator 60 is composed of an electric motor whose rotational speed can be changed by adjusting the DUTY. The operation of the actuator 60 is controlled in response to a control signal from the control device 70.

The control device 70 constitutes an electronic control unit of the clutch system 1. The control device 70 includes a microcomputer or microcontroller including a processor and a memory 71, and peripheral circuits thereof. The memory 71 includes a volatile memory and a non-volatile memory. Note that the memory 71 of the control device 70 is composed of a non-transitory, substantive storage medium.

A high-level ECU 100 for controlling the entire vehicle is connected to the control device 70 to be able to communicate bi-directionally. Further, sensors such as a rotation angle sensor 72 and a stroke sensor 73 are connected to an input side of the control device 70.

The rotation angle sensor 72 is a sensor that detects the rotation angle of the shift drum 30. The rotation angle sensor 72 is attached to a gear 51 connected to the shift drum 30. As shown in FIG. 5, the rotation angle sensor 72 outputs a voltage corresponding to the rotation angle of the shift drum 30 to the control device 70 as a sensor output. The rotation angle sensor 72 of the present embodiment is configured to be able to detect the rotation angle of the shift drum 30 in a range of 0 to 360 degrees. For example, the rotation angle sensor 72 has a set of magnetic detector elements arranged in directions orthogonal to each other with respect to the rotation axis CL. The rotation angle sensor 72 outputs an output value according to the rotation angle of the shift drum 30 based on a SIN signal output from one element and a COS signal output from the other element. Specifically, the rotation angle sensor 72 outputs a voltage corresponding to an arctangent value of the value obtained by dividing the SIN signal by the COS signal as an output value corresponding to the rotation angle of the shift drum 30. Note, FIG. 5 merely shows a straight line output (proportional relationship) for the sake of simplicity.

The stroke sensor 73 is a sensor that detects the amount of (vertical) displacement of the first dog member 11. The stroke sensor 73 is arranged at a position close to the first dog member 11. As shown in FIG. 6, the stroke sensor 73 outputs a voltage corresponding to the displacement amount of the first dog member 11 to the control device 70 as a sensor output.

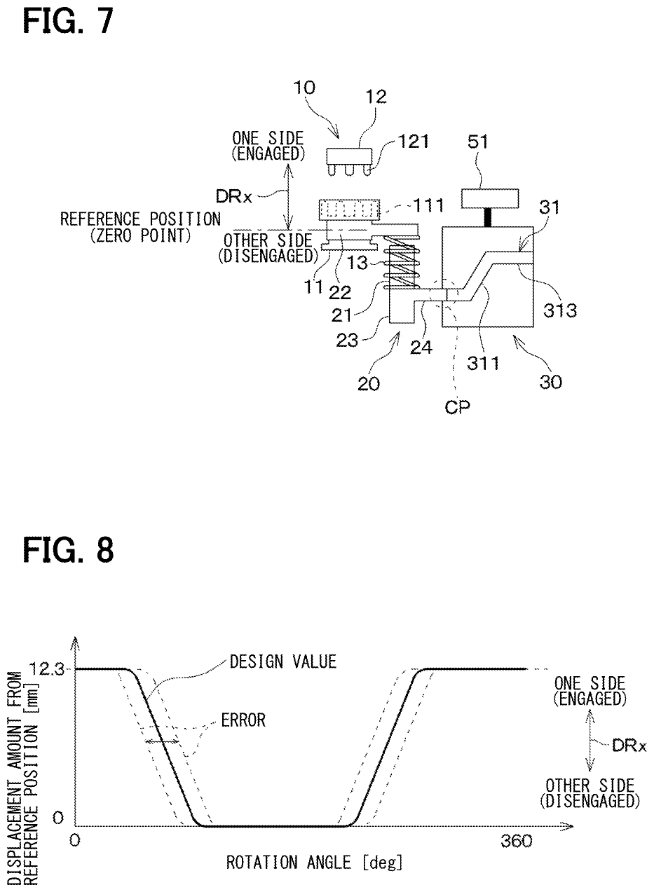

Here, in the present embodiment, as shown in FIGS. 4 and 7, the position of the first dog member 11 when the engagement pin 24 is at a connection point CP between the first slope groove portion 311 and the second flat groove portion 314 is assumed as a reference position (“zero point” in this example). From this reference position, the first dog member 11 is in a fully unengaged state (see FIG.

3), and is prepared to immediately be displaced upward by the first slope grooved portion 311 if the drum rotates in a first direction (causing the connection point CP to move “rightwards” in circumferential direction DRr shown in FIG. 4.

Further, in the present embodiment, the rotation angle of the shift drum 30 at the connection point CP is set as a design angle RefANG. The design angle RefANG is set to a predetermined angle (for example, 122.4 [deg]) at the time of product design or the like. The design angle RefANG is stored in the memory 71 so that the control device 70 can read it.

Here, in the clutch system 1, the displacement amount of the first dog member 11 changes according to the rotation angle of the shift drum 30. Specifically, the relationship between the rotation angle of the shift drum 30 and the amount of displacement of the first dog member 11 from the reference position changes according to the shape of the lead groove 31 as shown in FIG. 8.

The actuator 60 is connected to an output side of the control device 70. The control device 70 executes a computer program stored in the memory 71, and also executes various control processes according to the computer program.

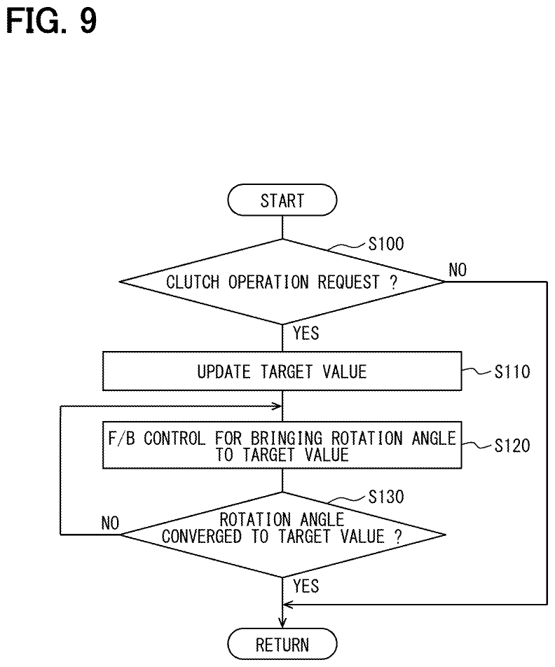

The control device 70 has a control unit 70a. The control unit 70a controls the actuator 60 so that a difference between a target value of the rotation angle of the shift drum 30 and a detection value of the rotation angle sensor 72 becomes small. Hereinafter, an engagement process (or operation process) of the clutch 10 performed by the control unit 70a will be described with reference to FIG. 9. A control routine shown in FIG. 9 is performed periodically or irregularly, for example, with an ignition switch of the vehicle turned on.

As shown in FIG. 9, the control unit 70a determines in step S100 whether or not there is an operation request for the clutch 10. For example, the control unit 70a determines whether or not an operation request signal requesting an operation of the clutch 10 from the upper ECU 100 has been received. The operation request signal includes (a) a disengage request signal requesting the clutch 10 to be switched from the “engaged state” to the “disengaged state” and (b) an engage request signal requesting the clutch 10 to be switched from the “disengaged state” to the “engaged state.”

When there is a request for operating the clutch 10, the control unit 70a shifts to the process of step S110, and when there is no request for operating the clutch 10, the control unit 70a skips the subsequent steps and exits from the operation process.

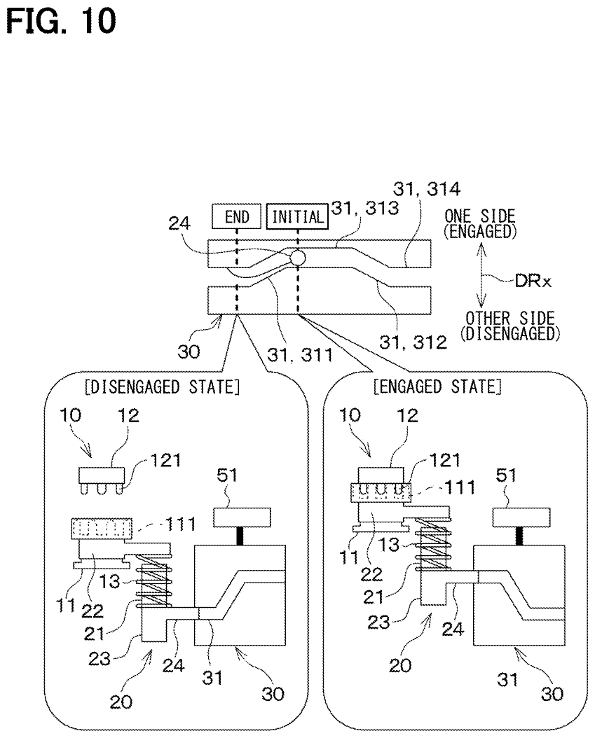

When there is an operation request for the clutch 10, the control unit 70a updates the target value of the rotation angle of the shift drum 30 in response to the operation request for the clutch 10 in step S110. For example, when there is a request to disengage the clutch 10, as shown in FIG. 10, the control unit 70a changes the target value to a (desired) rotation angle at which the clutch 10 is in the “disengaged state.” On the other hand, when there is a request to engage the clutch 10, the control unit 70a changes the target value to a (desired) rotation angle at which the clutch 10 is in the “engaged state.”

Subsequently, in step S120, the control unit 70a controls the operation of the actuator 60 by F/B control so that the (actual or measured) rotation angle of the shift drum 30 approaches the target value. “F/B control” is an abbreviation for feedback control.

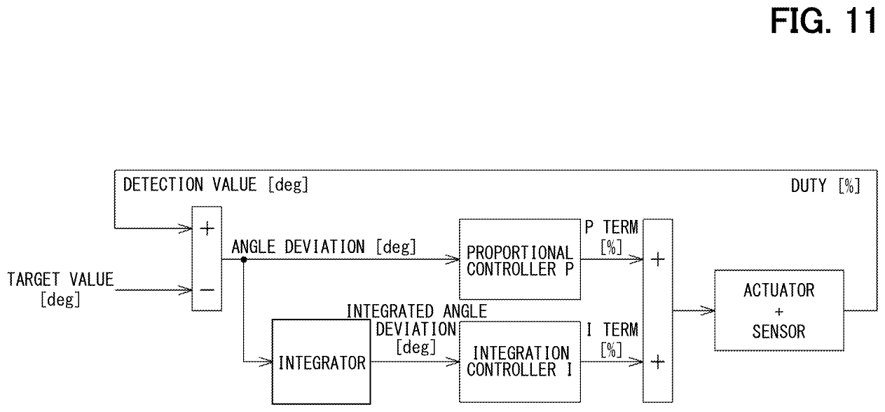

As shown in FIG. 11, the control unit 70a reduces an angle deviation between the detection value and the target value of the rotation angle sensor 72 by PI control using a proportional controller P and an integral controller I, for example. The F/B control is not limited to PI control, and may also be, for example, PID control using a proportional controller P, an integral controller I, and a differential controller D.

Subsequently, in step S130, the control unit 70a determines whether or not the rotation angle of the shift drum 30 has converged to the target value. That is, the control unit 70a determines whether or not the difference between the detection value of the rotation angle sensor 72 and the target value is equal to or less than a predetermined threshold value.

As a result, when the rotation angle has not yet converged to the target value, the control unit 70a returns to step S120, and continues the F/B control. On the other hand, when the rotation angle has already converged to the target value, the control unit 70a exits from the operation process.

When the actuator 60 is controlled based on the detection value of the rotation angle sensor 72 as in the above-mentioned operation process, it is important to detect the rotation angle of the shift drum 30 with high accuracy. However, in reality, as shown in FIG. 8, the design value intended at the time of product design may be blurred by, for example, an error at the time of assembly and at the time of manufacturing, an error due to aging (for example, wear of the lead groove 31) and the like.

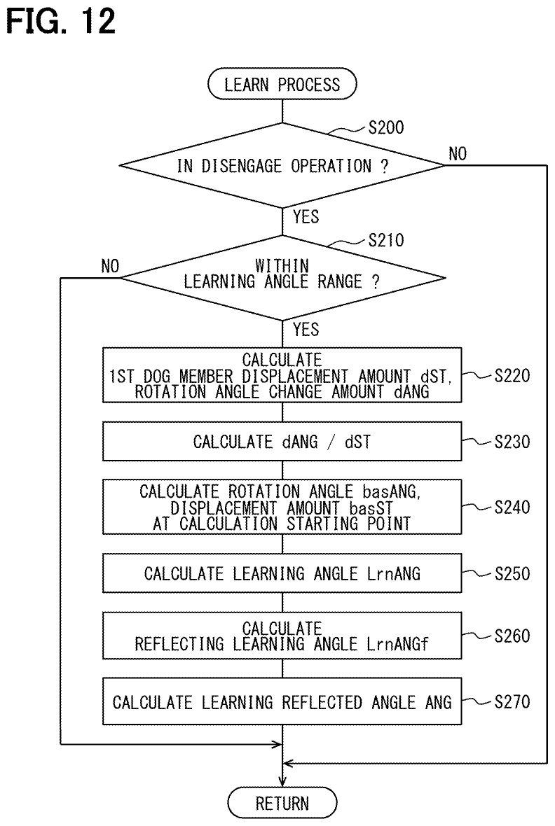

Therefore, the control device 70 is provided with an angle correction unit 70b that corrects the detection value of the rotation angle sensor 72 that detects the rotation angle of the shift drum 30. Hereinafter, a learn process of the detection value of the rotation angle sensor 72 performed by the angle correction unit 70b will be described with reference to FIG. 12. The control routine shown in FIG. 12 is performed, for example, every time or once every plurality of times when the operation process is performed.

As shown in FIG. 12, the angle correction unit 70b determines in step S200 whether or not the clutch 10 is in a disengage operation. Specifically, the angle correction unit 70b determines whether or not an operation process for switching the clutch 10 from the “engaged state” to the “disengaged state” is being performed.

When the clutch 10 is in the disengage operation, the angle correction unit 70b shifts to the process to step S210, and when the clutch 10 is not in the disengage operation, the angle correction unit 70b skips the subsequent steps and exits from the learn process.

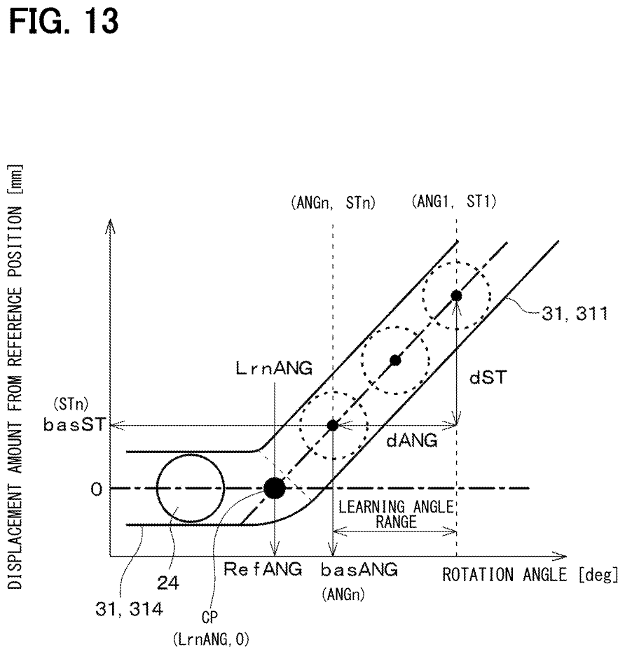

When the clutch 10 is in the disengage operation, the angle correction unit 70b determines in step S210 whether or not the rotation angle of the shift drum 30 is within a predetermined learning angle range. As shown in FIG. 13, the learning angle range is, for example, a range of the rotation angle of the first slope groove portion 311 close to the connection point CP, and is also a range of the rotation angle within which the first dog member 11 has the rotation angle linearly changing with respect to the displacement amount thereof.

When the rotation angle is within the learning angle range, the angle correction unit 70b shifts the process to step S220, and, when the rotation angle is outside the learning angle range, skips the subsequent steps and exits from the learn process.

In step S220, the angle correction unit 70b calculates (i) a displacement amount dST of the first dog member 11 and (ii) a change amount dANG of the rotation angle of the shift drum 30, per predetermined time of rotation of the shift drum 30 at a predetermined speed.

Specifically, the angle correction unit 70b calculates the displacement amount dST of the first dog member 11 by a mathematical formula F2 obtained based on the following mathematical formula F1.

dST=SUM{(STn−ST(n−1))+ . . . +(ST2−ST1)} Formula F1:

dST=STn−ST1 Formula F2:

Note that “STn” in the mathematical formula F2 is the displacement amount of the first dog member 11 at one (e.g., ending) end (i.e., at one extreme) of the learning angle range. Further, “ST1” in the mathematical formula F2 indicates the displacement amount of the first dog member 11 at other (e.g., starting) end (i.e., at other extreme) of the learning angle range.

Further, the angle correction unit 70b calculates the change amount dANG of the rotation angle of the shift drum 30 by a mathematical formula F4 obtained based on the following mathematical formula F3.

dANG=SUM{(ANGn−ANG(n−1))+ . . . +(ANG2−ANG1)} Formula F3:

dANG=ANGn−ANG1 Formula F4:

Note that “ANGn” in the formula F4 indicates the rotation angle of the shift drum 30 at one (e.g., ending) end of the learning angle range. Further, “ANG1” in the mathematical formula F2 indicates the rotation angle of the shift drum 30 at the other (e.g., starting) end of the learning angle range.

Subsequently, in step S230, the angle correction unit 70b divides the change amount dANG of the rotation angle of the shift drum 30 by the displacement amount dST of the first dog member 11 to calculate an inclination dANG/dST. The angle correction unit 70b of the present embodiment calculates the above-mentioned inclination dANG/dST after reaching the end of the learning angle range. Note that the angle correction unit 70b may calculate the inclination dANG/dST every time the change amount dANG of the rotation angle of the shift drum 30 and the displacement amount dST of the first dog member 11 are calculated while passing through the learning angle range.

Subsequently, in step S240, the angle correction unit 70b calculates a displacement amount STn as “basST” and a rotation angle ANGn as “basANG” at a calculation start point, which is an end value of the learning angle range.

Subsequently, in step S250, the angle correction unit 70b calculates the rotation angle of the shift drum 30 at the reference position as a learning angle LrnANG (also known as a corrected design angle, or a corrected reference angle), based on the correspondence between the displacement amount dST of the first dog member 11 and the change amount dANG of the rotation angle of the shift drum 30. The angle correction unit 70b calculates the learning angle LrnANG using, for example, the following mathematical formula F5.

LrnANG=basANG+basST×dANG/dST Formula F5:

Subsequently, in step S260, the angle correction unit 70b calculates an amount of deviation between the learning angle LrnANG and the design angle RefANG as a reflecting learning angle LrnANGf (also known as a learned reference angle deviation, or a learned correction). Note, depending upon the direction of rotation, formula F5 (modified) may be: LrnANG=basANG−basST×dANG/dST. The angle correction unit 70b calculates the reflecting learning angle LrnANGf using, for example, the following mathematical formula F6.

LrnANGf=LrnANG−RefANG Formula F6:

Subsequently, the angle correction unit 70b calculates, in step S270, a learning reflected angle ANG (also known as a corrected detected angle), and exits from the learn process. The angle correction unit 70b calculates the learning reflected angle ANG using, for example, the following mathematical formula F7 and using a detection value ANGdetected of the rotation angle sensor 72.

ANG=ANGdetected+LrnANGf Formula F7:

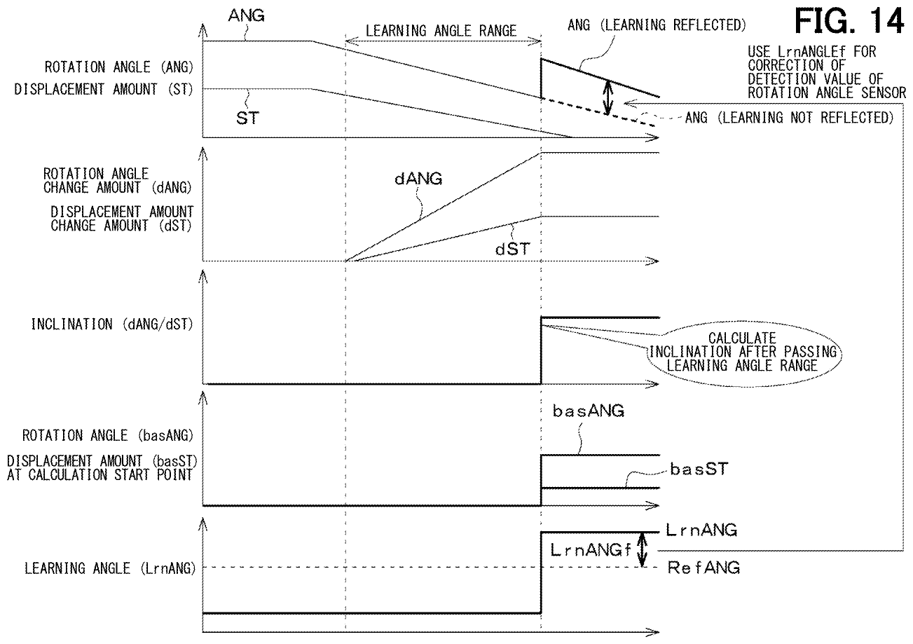

As shown in FIG. 14, the angle correction unit 70b uses the reflecting learning angle (or learned correction) LrnANGf, which is the amount of deviation between the learning angle LrnANG and the design angle RefANG. Then, the detection value ANGdetected of the rotation angle sensor 72 is corrected.

The drive device 40 of the clutch 10 described above includes an angle correction unit 70b that corrects the detection value of the rotation angle sensor 72 that detects the rotation angle of the shift drum 30. The angle correction unit 70b calculates the rotation angle of the shift drum 30 at the reference position as the learning angle LrnANG based on the correspondence between the displacement amount of the first dog member 11 and the change amount of the rotation angle of the shift drum 30 per predetermined time of rotation of the shift drum 30 at a predetermined speed. Then, the angle correction unit 70b corrects the detection value of the rotation angle sensor 72 (ANGdetected) so that the amount of deviation between the learning angle LrnANG and the design angle RefANG becomes small.

According to such correction scheme, the detection accuracy of the rotation angle of the shift drum 30 is improvable. In such manner, it is possible to suppress a malfunction of the clutch 10 such as a stroke of the clutch 10 in an unintended scene/situation.

In addition, the present disclosure does not assume that the lead groove 31 of the shift drum 30 is provided with an end wall on which the engagement pin 24 of the shift fork 20 abuts, thereby allowing an application of the present disclosure to a device in which no end wall is provided in the lead groove 31 of the shift drum 30.

Therefore, according to the present embodiment, it is possible to provide the drive device 40 of the clutch 10 capable of improving the detection accuracy of the rotation angle of the shift drum 30 while expanding the application target.

Further, according to the present embodiment, the following effects are achievable.

(1) The shift drum 30 is configured to be rotatable 360 degrees around the rotation axis CL. In addition, the rotation angle sensor 72 is configured to be able to detect the rotation angle of the shift drum 30 in the range of 0 to 360 degrees.

According to the present disclosure, even if the lead groove 31 of the shift drum 30 has no end wall and the shift drum 30 is configured to be rotatable 360 degrees around the rotation axis CL, the angle detection accuracy is improvable.

Further, if the shift drum 30 can rotate 360 degrees (repeatedly) around the rotation axis CL, the shortest shift drum rotation (e.g., a smaller rotation angle of the shift drum among a clockwise or a counter-clockwise rotation of the drum) enables switching of engage-disengage of one of multiple clutches 10 in a transmission device, when the present disclosure is applied. That is, such a drum rotation scheme greatly contributes to reduction of the time required for gear shifting.

(2) The clutch 10 has an elastic member 13. The angle correction unit 70b calculates the rotation angle of the shift drum 30 at the reference position as the learning angle LrnANG based on the correspondence between the displacement amount of the first dog member 11 and the change amount of the rotation angle of the shift drum 30 when the clutch 10 transitions from the engaged state to the disengaged state.

When the clutch 10 transitions from the engaged state to the disengaged state, the biasing force of the elastic member 13 does not affect the displacement amount of the first dog member 11. Therefore, the estimation accuracy of the rotation angle of the shift drum 30 is improvable by calculating the learning angle when the clutch 10 transitions from the engaged state to the disengaged state. Such a configuration contributes to the improvement of the detection accuracy of the rotation angle of the shift drum 30.

Alternatively, when the clutch begins the transition starting at the fully disengaged state shown in the right side of FIG. 3, the engaging teeth are not making any contact, and the elastic member is not compressed. Thus, in some embodiments starting from the fully disengaged state may increase estimation accuracy. In another embodiment, if the reference angle is associated with a disengaged state, then beginning the transition starting in the disengaged state may improve accuracy. In another embodiment, if the reference angle is associated with the engaged state, then starting the transition in the engaged state may improve accuracy.

(3) The drive device 40 includes a control unit 70a that controls the actuator 60 so that the difference between the target value of the rotation angle of the shift drum 30 and the detection value of the rotation angle sensor 72 becomes small. According to the drive device 40 of the present disclosure, the detection accuracy of the rotation angle of the shift drum 30 is improved and the controllability is improved, thereby an unintended operation of the clutch 10 is sufficiently suppressible. Further, according to the drive device 40 of the present disclosure, since no special operation is required, the detection value of the rotation angle sensor 72 is correctable without causing a sense of discomfort to a user/driver.

### Modification Example of the First Embodiment

Each of the slope groove portions 311 and 312 shown in the first embodiment extends linearly, but is not limited to such configuration, i.e., may also be bent in a quadratic or cubic curved shape, for example. In such case, by narrowing the learning angle range to the one that can be linearly approximated, the learning angle LrnANG can be calculated as in the first embodiment.

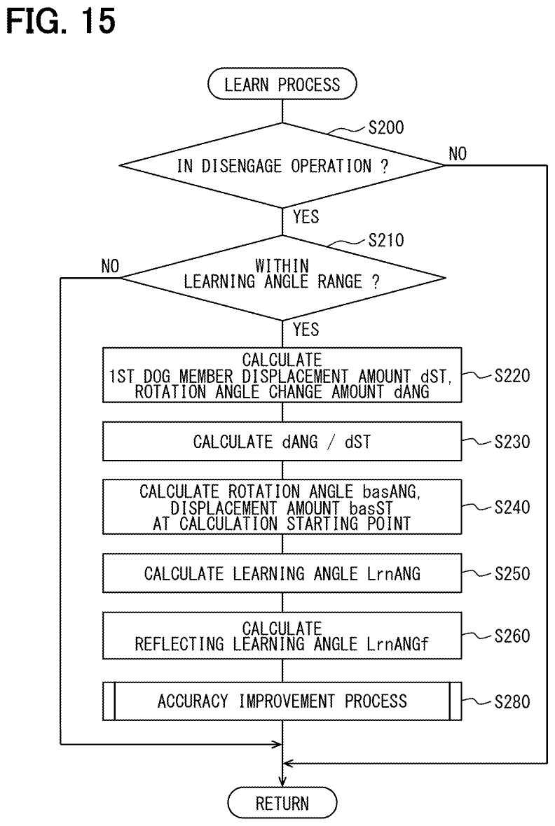

### Second Embodiment, FIGS. 15-17

Next, the second embodiment will be described with reference to FIGS.

15 to 17. In the present embodiment, a part of the learn process is different from the first embodiment. In the present embodiment, the parts/configuration different from the first embodiment will be mainly described.

In the learn process of the present embodiment, as shown in FIG. 15, the accuracy improvement process is performed after the reflecting learning angle LrnANGf is calculated. Hereinafter, the learn process of the present embodiment will be described with reference to FIG. 15. Since the processes of steps S200 to S260 shown in FIG. 15 are the same as the processes of steps S200 to S260 described in the first embodiment, the description thereof is omitted.

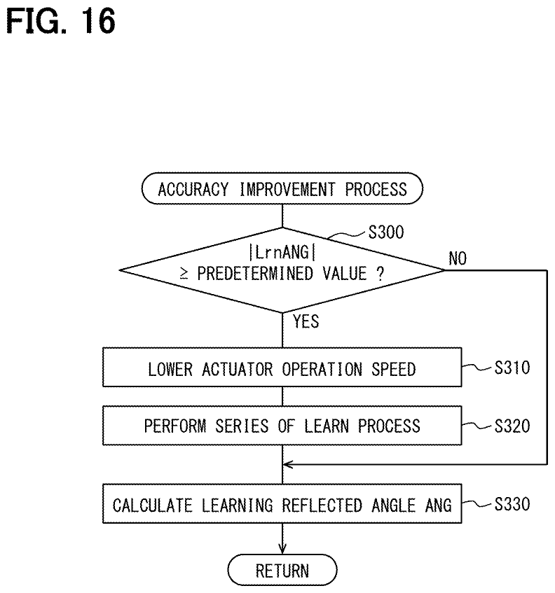

As shown in FIG. 15, the angle correction unit 70b calculates the reflecting learning angle LrnANGf in step S260, and then performs the accuracy improvement process in step S280. The accuracy improvement process is a process for improving the detection accuracy of the rotation angle of the shift drum 30. Hereinafter, the accuracy improvement process performed by the angle correction unit 70b will be described with reference to FIG. 16.

As shown in FIG. 16, the angle correction unit 70b determines in step S300 whether or not an absolute value of the reflecting learning angle LrnANGf is equal to or greater than a predetermined value. In other words, the angle correction unit 70b determines whether or not the amount of deviation between the learning angle LrnANG and the design angle RefANG is equal to or greater than a predetermined value. This predetermined value may be set to a value set in advance, an average value of the previously calculated reflecting learning angles LrnANGf, or the like.

When the absolute value of the reflecting learning angle LrnANGf is equal to or greater than a predetermined value, there is a concern that the calculation error of the reflecting learning angle LrnANGf is large. Therefore, when an absolute value of the reflecting learning angle LrnANGf is equal to or greater than a predetermined value, the angle correction unit 70b recalculates the reflecting learning angle LrnANGf.

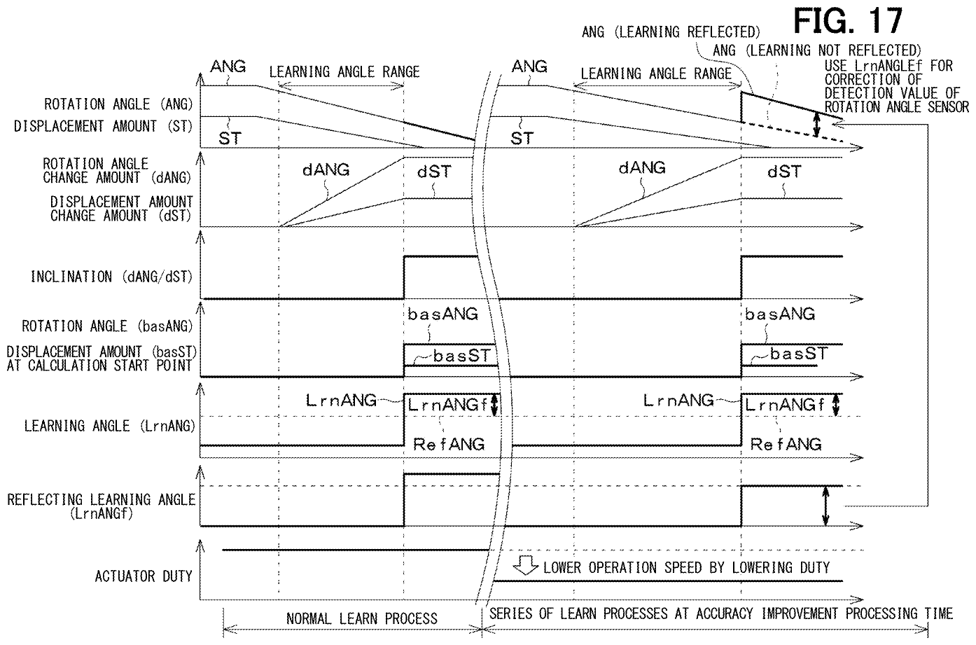

The angle correction unit 70b of the present embodiment lowers the operation speed of the actuator 60 in step S310. Specifically, as shown in a lowermost part of FIG. 17, the angle correction unit 70b lowers the DUTY, which is the energization rate of the actuator 60 when the learn process is performed next, than before. As a result, the shift drum 30 rotates at a speed slower than the predetermined speed the next time the operation process for switching the clutch 10 to the “disengaged state” is performed. Note that the predetermined speed is the rotation speed of the shift drum 30 set at the time of the operation process.

Subsequently, in step S320, the angle correction unit 70b performs the learn process from steps S200 to S260 shown in FIG. 15 at the timing of switching the clutch 10 to the “disengaged state.” Specifically, the angle correction unit 70b calculates a displacement amount dST of the first dog member 11 and a change amount dANG of the rotation angle of the shift drum 30 per predetermined time of rotation of the shift drum 30 at a speed lower than a predetermined speed. Then, the angle correction unit 70b recalculates the rotation angle of the shift drum 30 at the reference position as the learning angle LrnANG based on the correspondence between the displacement amount dST of the first dog member 11 and the change amount dANG of the rotation angle of the shift drum 30. When thr recalculation is complete, the angle correction unit 70b shifts the process to step S330. On the other hand, when the absolute value of the reflecting learning angle LrnANGf is less than a predetermined value, it is considered that the calculation error of the reflecting learning angle LrnANGf is small. Therefore, the angle correction unit 70b skips steps S310 and S320 and shifts the process to step S330. Note that, when the absolute value of the reflecting learning angle LrnANGf is less than a predetermined value, the angle correction unit 70b determines the operation speed of the actuator 60 so that the shift drum 30 rotates at a predetermined speed.

In step S330, the angle correction unit 70b calculates the learning reflected angle ANG and exits from the learn process. The angle correction unit 70b calculates the learning reflected angle ANG using the mathematical formula F7 described in the first embodiment. That is, as shown in FIG. 17, the angle correction unit 70b corrects the detection value of the rotation angle sensor 72 by using the reflecting learning angle LrnANGf, which is the amount of deviation between the learning angle LrnANG and the design angle RefANG.

Other configurations are the same as those in the first embodiment. The drive device 40 of the clutch 10 of the present embodiment can obtain the same effects as that of the first embodiment from the same or equivalent configuration as the first embodiment.

Further, according to the present embodiment, the following effects are achievable.

(1) The angle correction unit 70b of the present embodiment determines whether or not the amount of deviation between the learning angle LrnANG and the design angle RefANG is equal to or greater than a predetermined value. When the amount of deviation is equal to or greater than a predetermined value, the angle correction unit 70b calculates the displacement amount of the first dog member 11 and the shift drum 30 and the change amount of the rotation angle per predetermined time of rotation of the shift drum 30 at a speed lower than the predetermined speed. Further, the angle correction unit 70b recalculates the rotation angle of the shift drum 30 at the reference position as the learning angle LrnANG based on the correspondence between the displacement amount of the first dog member 11 and the change amount of the rotation angle of the shift drum 30. Then, the angle correction unit 70b corrects the detection value of the rotation angle sensor 72 using the recalculated learning angle LrnANG.

Here, it might be possible to improve the estimation accuracy of the rotation angle of the shift drum 30 by constantly slowing down the rotation speed of the shift drum 30, but in such case, engaging and disengaging the clutch 10 take longer time.

On the other hand, the angle correction unit 70b of the present embodiment recalculates the learning angle LrnANG when the shift drum 30 is rotated at a speed slower than the predetermined speed in case that the deviation amount between the learning angle LrnANG and the design angle RefANG is equal to or greater than a predetermined value. As a result, the estimation accuracy of the rotation angle of the shift drum 30 is improvable while suppressing the increase of time for engaging and disengaging the clutch 10.

### Modification Example of the Second Embodiment, Not Shown

In the accuracy improvement process of the second embodiment, when the reflecting learning angle LrnANGf is equal to or greater than a predetermined value, the shift drum 30 is rotated by a speed lower than the predetermined value at the next timing when the clutch 10 is switched to the “disengaged state,” which is only an example. Thus, rotating the shift drum 30 at a speed lower than the predetermined speed is not limiting one, and other examples may also be adoptable. In the accuracy improvement process, when the reflecting learning angle LrnANGf is equal to or greater than a predetermined value, the shift drum 30 may be forcibly rotated at a speed lower than the predetermined speed to engage and disengage the clutch 10, and the learning angle LrnANG may be recalculated during such operation. Further, in the accuracy improvement process, though the rotation speed of the shift drum 30 is lowered when the reflecting learning angle LrnANGf is equal to or greater than a predetermined value, the rotation speed of the shift drum 30 may also be lowered when other condition(s) is/are satisfied.

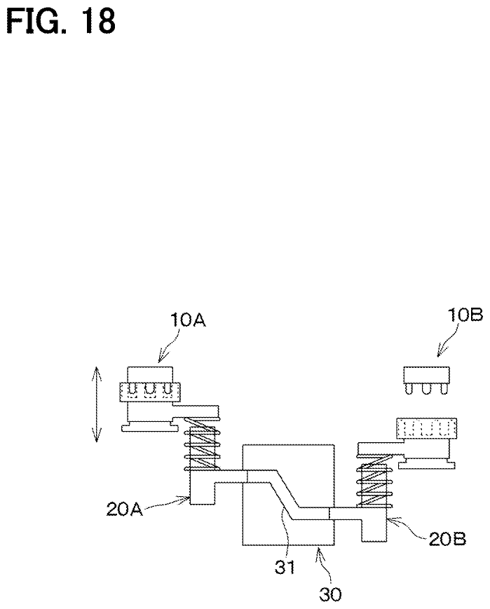

### Third Embodiment, FIGS. 18-22

Next, the third embodiment will be described with reference to FIGS. 18 to 22. In the present embodiment, an example in which the drive device 40 of the present disclosure is applied to a transmission will be described. In the present embodiment, the parts/configuration different from the first embodiment will be mainly described.

As shown in FIG. 18, the single shift drum 30 has a first clutch 10A connected thereto via a first shift fork 20A, and has a second clutch 10B connected thereto via a second shift fork 20B. Since the first clutch 10A and the clutch 10B are configured in the same manner as the clutch 10 described in the first embodiment, the description thereof is omitted. Further, since the first shift fork 20A and the second shift fork 20B are configured in the same manner as the shift fork 20 described in the first embodiment, the description thereof is also omitted.

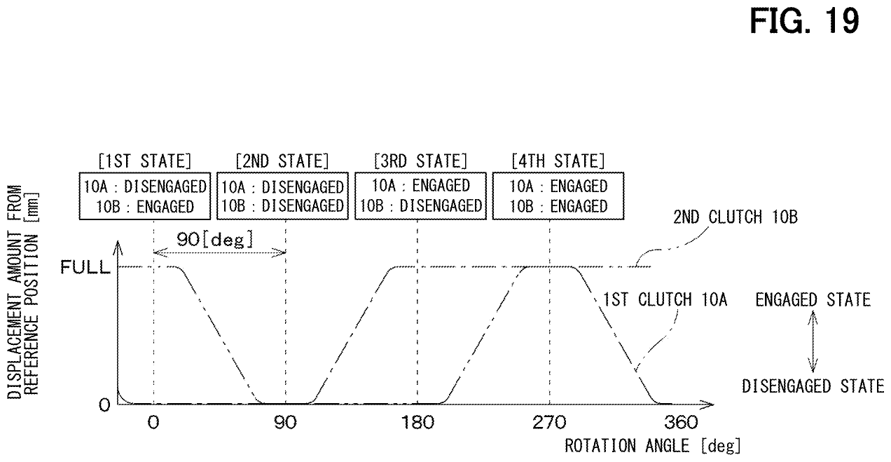

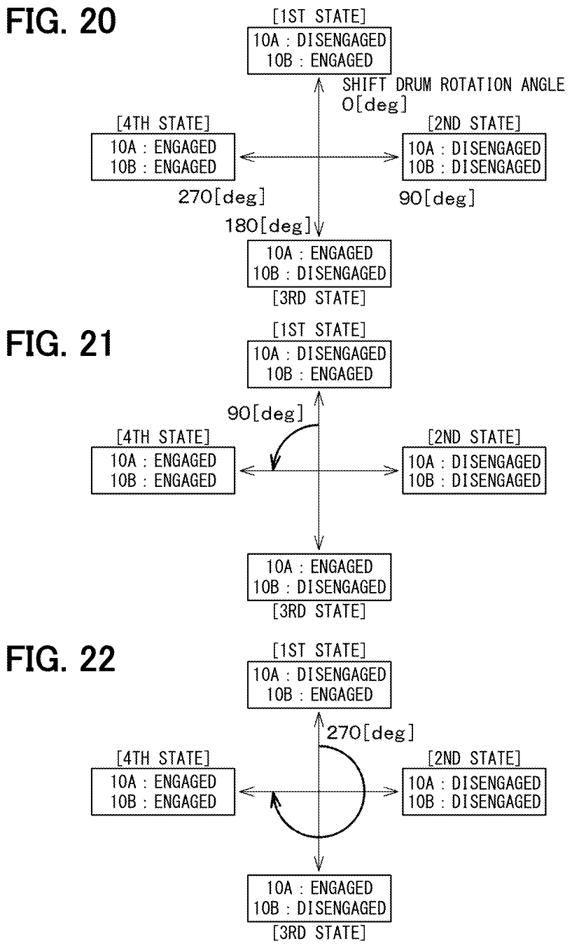

The first shift fork 20A and the second shift fork 20B are connected to different positions in the lead groove 31. Specifically, the shift forks 20A and 20B are connected to the shift drum 30 as shown in FIGS. 19 and 20. That is, the first shift fork 20A is connected to the shift drum 30 in a manner that (a) puts the first clutch 10A in an engaged state when the rotation angle of the shift drum 30 is approximately in a range of 180 to 270 degrees, and (b) puts the first clutch 10A in a disengaged state when the rotation angle of the shift drum 30 is approximately in a range of 0 to 90 degrees. On the other hand, the second shift fork 20B is connected to the shift drum 30 in a manner that (a) puts the second clutch 10B in a disengaged state when the rotation angle of the shift drum 30 is approximately in a range of 90 to 180 degrees, and (b) puts the second clutch 10B in an engaged state when the rotation angle of the shift drum 30 is approximately in a range of 270 to 360 degrees.

In such manner, the clutches 10A and 10B are switchable between a first state, a second state, a third state, and a fourth state. The first state is a state in which the first clutch 10A is in the disengaged state and the second clutch 10B is in the engaged state. The second state is a state in which both of the clutches 10A and 10B are in the disengaged state. The third state is a state in which the first clutch 10A is in the engaged state and the second clutch 10B is in the disengaged state. The fourth state is a state in which both of the clutches 10A and 10B are in the engaged state.

The transmission configured in such manner can engage and disengage one of the clutches 10A and 10B with the shortest rotation angle of the shift drum 30. For example, when switching from the first state to the fourth state to engage and disengage the first clutch 10A, the shift drum 30 is rotated by 90 degrees as shown in FIG. 21 That is, it is not necessary to rotate the shift drum 30 in one direction by 270 degrees as shown in FIG. 22, but to rotate the shift drum 30 in the other direction only by 90 degrees as shown in FIG. 21, for the first clutch 10A to be intermittently switched from the first state to the fourth state. Such an operation cannot be realized if an end wall is provided in the lead groove 31 of the shift drum 30.

Other configurations are the same as those in the first embodiment. The transmission of the present embodiment can achieve the same effects as those of the first embodiment from the same or equivalent configuration as that of the first embodiment.

(1) In the transmission of the present embodiment, the shift drum 30 can rotate 360 degrees around the rotation axis CL, so that one clutch can be engaged and disengaged by the shortest rotation angle of the shift drum 30. That is, such a drum rotation scheme greatly contributes to reduction of the time required for gear shifting.

### Other Embodiments, Not Shown

Although representative embodiments of the present disclosure have been described above, the present disclosure is not limited to the embodiments described above, and various modifications can be made, for example, as follows.

The shift drum 30 of the above-described embodiment is configured to be rotatable 360 degrees around the rotation axis CL, but the present disclosure is not limited to such configuration, and the rotation range may also be less than 360 degrees. That is, the lead groove 31 of the shift drum 30 may have an end wall for abutting and stopping the engagement pin 24. In such case, the rotation angle sensor 72 may have a detection range of less than 360 degrees corresponding to the rotation angle of the shift drum 30.

The angle correction unit 70b of the above-described embodiment calculates the learning angle LrnANG based on the correspondence between the displacement amount of the first dog member 11 and the change amount of the rotation angle of the shift drum 30 when the clutch 10 transitions to the disengaged state. However, the present disclosure is not limited to such configuration. The angle correction unit 70b may calculate the learning angle LrnANG based on the correspondence between the displacement amount of the first dog member 11 and the change amount of the rotation angle of the shift drum 30 when the clutch 10 transitions to the engaged state.

The clutch 10 of the above-described embodiment is composed of a dog clutch, but the clutch 10 is not necessarily limited to such type, and may be composed of other type. It may be desirable that the clutch 10 is provided with the elastic member 13, but the elastic member 13 may be omitted from the clutch 10.

In the above-described embodiment, an example in which the drive device 40 of the present disclosure is applied to the clutch system 1 of a hybrid vehicle has been described, but the application target of the drive device 40 is not limited to the hybrid vehicle. The drive device 40 may also be applied to a drive device that drives a device other than a vehicle. Further, the drive device 40 may also be applied to a transmission or the like in which a plurality of clutches 10 are engaged and disengaged by using a shift drum 30 in which a plurality of lead grooves 31 are formed.

In the embodiments described above, it is needless to say that the elements configuring the embodiments are not necessarily essential except in case (i) where those elements are clearly indicated as essential in particular, (ii) where those elements are considered as obviously essential in principle, and the like.

In the embodiments described above, the present disclosure is not limited to a specific number of components of the embodiments, regarding the numbers, numerical values, quantities, ranges, and the like, except that it is expressly indicated as specific or when it is obviously limited to such specific number in principle, and the like.

In the embodiments described above, when referring to the shape, positional relationship, and the like of a component and the like, it is not limited to the shape, positional relationship, and the like, except for a case where it is specifically indicated, a case where it is fundamentally limited to the specific shape, positional relationship, and the like.

The control unit and methods thereof of the present disclosure may be realized by a dedicated computer that is provided by configuring a processor and memory programmed to perform one or more functions embodied by a computer program.

The control unit and its method of the present disclosure may be realized by a dedicated computer that is provided by configuring a processor with one or more dedicated hardware logic circuits.

The control unit and its method of the present disclosure may be realized by one or more dedicated computers that are provided by configuring a combination of (A) a processor and memory programmed to perform one or more functions and (B) a processor composed of one or more hardware logic circuits.

Further, the computer program may also be stored in a computer-readable, non-transitory, tangible storage medium as instructions to be executed by a computer.

The following descriptive names for the reference characters may be used:

refANG is a design angle (reference angle);

LrnANG is a learning angle (aka [=as known as] corrected design angle, or corrected reference angle);

LrnANGf is a reflecting learning angle (aka learned reference angle deviation, or learned correction, or learned deviation);

ANG is a learning reflected angle (aka corrected detected angle)

basST (or STn) is a displacement amount at an end value of the learning angle range; and

basANG is a rotation angle at an end value of the learning angle range.

What is claimed is:

1. A drive device for driving a clutch capable of switching between (i) an engaged state in which a pair of engaging portions rotate integrally and (ii) a disengaged state in which the pair of engaging portions do not rotate integrally, the drive device comprising:
an actuator rotating a shift drum having a lead groove formed on an outer peripheral surface around a predetermined rotating shaft; and
an angle correction unit correcting a detection value of a rotation angle sensor that detects a rotation angle of the shift drum, wherein
one of the pair of engaging portions is connected to the shift drum via a shift fork having an engagement pin that engages with the lead groove,
the shift fork engages and disengages the clutch by displacement in an axial direction of the rotating shaft according to a shape of the lead groove,
the lead groove includes (a) a slope groove portion that is inclined with respect to the axial direction and displaces the one of the engaging portions in the axial direction, and (b) a flat groove portion that stops the axial displacement of the one of the engaging portions, which is connected to the slope groove portion,
assuming that (A) a position of the one of the engaging portions when the engagement pin is at a connection point between the slope groove portion and the flat groove portion is used as a reference position, and (B) a rotation angle of the shift drum when the engagement pin is at the connection point is used as a design angle,
the angle correction unit
calculates the rotation angle of the shift drum at the reference position as a learning angle based on a correspondence between (a) the displacement amount of the one of the engaging portions and (b) the change amount of the rotation angle of the shift drum per predetermined time of rotation of the shift drum at a predetermined speed, and
corrects the detection value of the rotation angle sensor so that the amount of deviation between the learning angle and the design angle becomes small.

2. The drive device of claim 1, wherein
when the amount of deviation is equal to or greater than a predetermined value, the angle correction unit recalculates the rotation angle of the shift drum at the reference position as the learning angle based on the correspondence between the displacement amount of the one of the engaging portions and the change amount of the rotation angle of the shift drum per predetermined time of rotation of the shift drum at a speed lower than the predetermined speed, and corrects the detection value of the rotation angle sensor by using the recalculated learning angle.

3. The drive device of claim 1, wherein
the shift drum is configured to be rotatable 360 degrees around the rotation axis, and
the rotation angle sensor is configured to be capable of detecting the rotation angle of the shift drum in a range of 0 to 360 degrees.

4. The drive device of claim 1, further comprising:
the clutch includes an elastic member that is compressed when transitioning from the disengaged state to the engaged state, wherein
the angle correction unit calculates the rotation angle of the shift drum at the reference position as the learning angle based on the correspondence between the displacement amount of the one of the engaging portions and the change amount of the rotation angle of the shift drum when the clutch transitions from the engaged state to the disengaged state.

5. The drive device of claim 1, further comprising:
a control unit controlling the actuator so that a difference between a target value of the rotation angle of the shift drum and the detection value of the rotation angle sensor becomes small.

6. A drive device for driving a clutch, wherein the clutch is configured to switch between (i) an engaged state in which a pair of engaging portions rotate integrally and (ii) a disengaged state in which the pair of engaging portions do not rotate integrally, the drive device comprising:
an actuator rotating a shift drum including a lead groove formed on an outer peripheral surface around a rotating axis; and
an angle correction unit configured to correct a detection value of a rotation angle sensor that detects a rotation angle of the shift drum, wherein
the pair of engaging portions includes a mobile engaging portion and a fixed engaging portion, and the mobile engaging portion is connected to the shift drum via a shift fork including an engagement pin that engages with the lead groove,
the shift fork engages and disengages the clutch by displacement in an axial direction according to a shape of the lead groove as the shift drum rotates,
the lead groove includes: (a) a slope groove portion that is inclined with respect to the axial direction and displaces the mobile engaging portion in the axial direction, and (b) a flat groove portion that stops the axial displacement of the mobile engaging portion, which is connected to the slope groove portion,
a connection point in the lead groove defines a reference position, and is located where the slope groove portion meets the flat groove portion,
a rotation angle of the shift drum when the engagement pin is at the connection point is defined as a design angle, and
the angle correction unit:
(i) calculates the rotation angle of the shift drum at or near the reference position as a learning angle based on a correspondence between (a) a measured displacement amount of the mobile engaging portion and (b) a measured change amount of the rotation angle of the shift drum corresponding to the measured displacement amount of the mobile engaging portion, wherein measurements are made based on a predetermined time of rotation of the shift drum at a predetermined speed in a region of the slope groove portion near the reference position, and
(ii) corrects the detection value of the rotation angle sensor based on an amount of deviation between the learning angle and the design angle.

7. The drive device of claim 6, wherein upon a determination that the amount of deviation is equal to or greater than a predetermined value
the angle correction unit calculates, using a lowered shift drum speed relative to the predetermined speed,
(i) an improved measured displacement amount,
(ii) an improved measured change amount, and
(iii) an improved amount of deviation between an improved learning angle and the design angle; and
the angle correction unit corrects the detection value of the rotation angle sensor based on the improved amount of deviation.

8. The drive device of claim 6, wherein
the shift drum is configured to be rotatable 360 degrees around the rotation axis, and
the rotation angle sensor is configured to be capable of detecting the rotation angle of the shift drum in a range of 0 to 360 degrees.

9. The drive device claim 6, wherein:
the clutch includes an elastic member that is compressed during part of transitioning from the disengaged state to the engaged state, and
the angle correction unit calculates the measured displacement amount, the measured change amount, and the amount of deviation between the learning angle and the design angle in a region where the clutch transitions from the engaged state to the disengaged state.

10. The drive device of claim 6, further comprising:
a control unit controlling the actuator so that a difference between a target value of the rotation angle of the shift drum and the detection value of the rotation angle sensor becomes small.

11. A drive device comprising:
at least one processor; and
a non-transitory computer-readable storage medium,
wherein the drive device is configured to control a clutch,
wherein the clutch includes:
(i) a shift drum, wherein the shift drum is configured to rotate about a rotational axis, wherein the shift drum includes a lead groove, and wherein the lead groove includes a disengaged flat groove portion and a first slope groove portion,
(ii) a shift fork including an engagement pin configured to penetrate the lead groove, configured to move within the lead groove when the shift drum rotates, and configured to move vertically when the engagement pin moves within the first slope groove portion while the shift drum rotates,
(iii) a mobile engaging portion attached directly or indirectly to the shift fork, such that the mobile engaging portion tends to move vertically when the shift fork moves vertically,
(iv) a static engaging portion configured to receive and to be rotated by the mobile engaging portion,
(v) a rotation angle sensor configured to measure a rotation angle of the shift drum, wherein a reference angle is defined by a connection point where the disengaged flat groove portion meets the first slope groove portion under design conditions,
(vi) a stroke sensor configured to measure a displacement amount of the mobile engaging portion vertically, wherein a zero displacement amount is defined when the engagement pin is in the disengaged flat groove portion, and
wherein the drive device is configured to control engagement and disengagement of the mobile engaging portion by rotating the shift drum based on:
(i) a target rotation angle of the shift drum associated with a target displacement of the mobile engaging portion, and
(ii) a corrected detected angle of the shift drum.

12. The drive device of claim 11, wherein the drive device is configured to perform a learning process to calculate a learned deviation for calculating a corrected measured rotation angle, and wherein the learning process includes:
determine that the drive device is performing a disengagement operation;
determine that the shift drum is within a learning angle range, wherein the learning angle range is near the connection point and includes a linear portion of the first slope groove portion;
measure a first displacement amount and a first angle within the learning angle range;
measure a second displacement amount and a second angle within the learning angle range;
based upon the measurements within the learning angle range, calculate a corrected reference angle associated with the first slope groove portion reaching a zero displacement;
calculate a learned deviation as a difference between the corrected reference angle and the reference angle;
calculate the corrected detected angle by adding the learned deviation to a detected rotation angle.
